(19) United States
(12) Patent Application Publication
(10) Pub. No.: US 2008/0221868 A1
(43) Pub. Date: Sep. 11, 2008

(54) Digital universal language

(76) Inventors: Einat H. Melnick, Tel-Aviv (IL); Geoffrey L. Melnick, Tel-Aviv (IL); David Cohen, Tel-Aviv (IL); Eldar Nir, Tel-Aviv (IL)

Correspondence Address: Martin D. Moynihan;PRTSI, Inc., P.O. Box 16446, Arlington, VA, 22215, US

(21) Appl. No.: 12/073,425

(22) Filed: Mar. 5, 2008

Related U.S. Application Data
(63) Continuation-in-part of application No. PCT/IL2006/001027, filed on Sep. 5, 2006.
(60) Provisional application No. 60/907,219, filed on Mar. 26, 2007.

(30) Foreign Application Priority Data
Sep. 5, 2005 (GB) 0518006.2
Feb. 22, 2008 (GB) 0803267.4

(51) Int. Cl. G06F 17/20

(52) U.S. Cl. 704/8

(57) ABSTRACT

A numeric, hierarchical knowledge classification system, (e.g., Dewey Decimal Classification (DDC)) of concepts, is used for universal annotation. For example, “game” (DDC=799) relates to hunting and “game” (DDC=794.105), to chess. The universal annotation may be combined with human-aided machine translation, so individuals can tag their documents in the source language, simultaneously specifying meanings in the source and target languages, exercising control over what is said in the target language. Multilingual communication, by e-mails, forums, blogs, Wikipedia and the like may proceed, with each participant working in his tongue and tagging his writing with universal concepts. Moreover, a Universal System of Expression (USE) is introduced, based on the universal concepts. USE documents may be generated as byproducts of human-aided machine translations between any two natural languages that recognize USE, for fully automatic translation to other languages, on demand, and libraries of USE documents may be formed.

### RELATED APPLICATIONS

The present application is a Continuation-In-Part (CIP) of PCT Patent Application No. PCT/IL2006/001027, filed on Sep. 5, 2006, which claims priority of United Kingdom (UK) Patent Application No. 0518006.2, filed on Sep. 5, 2005. The present application also claims priority from U.S. Provisional Application No. 60/907,219, filed on Mar. 26, 2007, and United Kingdom (UK) Patent Application No. 0803267.4 filed on Feb. 22, 2008. The contents of all of the applications mentioned above are incorporated herein by reference.

### FIELD OF THE INVENTION

The present invention relates to a digital, translingual sense code and a system of operators, for generating a digital universal language, which is substantially unequivocal in sense and syntax.

### BACKGROUND OF THE INVENTION

For machine translation to be precise, a clear-cut correspondence is necessary between the source and target. Yet, words often have many senses, and the correspondence between the source and target is ambiguous and elusive—far from clear-cut.

One reason for the different senses is that language develops and grows by association.

For example, the word, verse—a line of poetry, comes from the Latin past participle of vertere, to turn, the association being that the lines of a poem resemble the lines a plough forms in a field, as it turns the soil. Many additional meanings to verse have developed, associated with a line of poetry, for example, verse as a poem, verse as a metrical or rhymed composition distinct from prose, verse as poetry in general, verse as the work of a poet, and verse as a metrical writing without depth or artistic merit. Yet, the association between a line in a poem and a ploughed field, which has led to all these senses, is culture dependent, and could have developed only in an agricultural community; it would have made no sense to nomads. When nomads think of a line, they think of a caravan—a single file of pack animals; indeed, in Hebrew, a line in a poem and a caravan are of the same root.

The word, bank, as a financial establishment, comes from Old Italian banca, a bench, a moneychanger's table, the association being that bank transactions are formed across a table. And while bank, originally referred to a place of storage of money, the association has now been expanded to include places of storage of data, blood, and other materials. Yet, the association between a bank and a bench is also culture dependent, and could have only developed where benches were used for transactions.

Associations are natural to the human mind, and language continues to grow and develop by new associations, constantly generating new senses to existing words. For example, to milk as to draw nourishing fluid from a teat or udder has led for example, to the following: to milk venom from a snake, to milk a witness for information, or to milk money and benefits from someone. With the advent of nuclear medicine, a new sense developed, to milk Tc-99m from a technetium generator, for producing radiopharmaceuticals, such as Tc-99m-sestamibi, or Tc-99m-Teboroxime.

At times the new sense is momentary, used in analogy, and applying for a particular task. At other times, the new sense catches on and becomes widespread. Yet, senses that grow from associations are both varied and fluid; it is practically impossible to catalog in a dictionary all senses associated with a word.

Another reason for the different senses is different origins.

For example, date, as a sweet, edible, oblong fruit, is from the Greek daktulos, finger, the date fruit having a finger shape. Date, as a time defined by day, month, and year, is from the Latin data, issued (in Rome), on a certain day.

Similarly, bank, as a natural incline or the slope adjoining a river, is of Scandinavian origin, while bank, as a financial establishment, is of French and Old Italian origin.

In translation, one converts from a word associated with senses developed in one ancient system of origins and associations to a word associated with senses developed in another ancient system of origins and associations. The results may be unknown and unpredictable.

Moreover, ambiguities in language include also ambiguities in word functions, and in parts of speech. Words are often used in different functions, for example, “order,” as a transitive verb and as a noun. Moreover, nouns may function as attributive nouns, being in effect, adjectives, for example, “university,” in “university student.” Furthermore, both the participle form, e.g., “increased” and the gerund, e.g. “increasing,” may function as verbs and as adjectives. Due to word function ambiguities, parts of speech may be difficult to determine. For example, in “High health care costs result in poor health care availability,” each of “care,” “costs,” and “result” may function as a noun or verb. Is “care” the subject and “costs” the predicate, or is “costs” the subject and “result” the predicate?

The function and part of speech ambiguities further complicate translation.

### SUMMARY OF THE INVENTION

A numeric and hierarchical knowledge classification system, (e.g., the Dewey Decimal Classification (DDC)), which defines concepts, is used for universal annotation. For example, game (DDC=799) relates to Fishing, hunting & shooting, and game (DDC=794.105) relates to chess. The universal annotation may be combined with human-aided machine translation, so individuals can tag their documents and control their meanings in other languages. They know that “game” as DDC=794.105 relates to chess, universally, so they can control how “game” will be translated to other languages. Multilingual communication, by e-mails, forums, blogs, Wikipedia and the like may proceed, with each participant working in his tongue and tagging his writing with universal concepts, while others see it in their tongues. Moreover, a Universal System of Expression (USE) may be generated by employing (1) a vector format for conjugating the numeric concepts by function, case, gender, person, tense, and the like, to create word-like numeric entities, of substantially singular sense; and (2) a syntax code of operators, defining syntactic relations. For example 0,1,1,3,1,1,1,1 X 794.105,2,1,3,1,1,1,1 : 794.105,1,2,3,0,1,0,3 means “He played chess,” and 0,1,1,3,1,1,1,1 X 799, 2,1,3,1,1,1,1 : 799,1,2,3,0,1,0,2 means “He hunted game.” Documents in USE may be accessible for fully automatic translation to a plurality of languages, on demand, and libraries of USE documents may be formed. USE documents may be generated as byproducts of human-aided machine translations between any two natural languages that recognize USE.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the patent specification, including definitions, will control. In addition, the materials, methods, and examples are illustrative only and not intended to be limiting.

Implementation of the method and system of the present invention involves performing or completing selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

The invention is herein described, by way of example only, with reference to the accompanying drawings, in which:

FIG. 1 schematically illustrates a domain of senses and a domain of words, as defined by the present invention;

FIG. 2 schematically illustrates the construction of a translingual sense code and a translingual-sense-code lexicon, in accordance with preferred embodiments of the present invention;

FIG. 3 illustrates a mapping of English dictionary entries, which may be words, phrases, or idioms, into a translingual sense code, for extracting sense stems in accordance with preferred embodiments of the present invention;

FIG. 4 is a transformation of FIG. 3 to the domain of senses, in accordance with preferred embodiments of the present invention; and

FIG. 5 illustrates a system for expressing the translingual sense code in digital format, using a vector of “n” natural numbers, in accordance with an embodiment of the present invention;

FIG. 6 schematically illustrates a computerized system, for language disambiguation for a plurality of natural languages, in accordance with a preferred embodiment of the present invention;

FIG. 7 schematically illustrates another computerized system, in accordance with a preferred embodiment of the present invention; and

FIG. 8 schematically illustrates the additions of language-specific concepts to the MSD, in accordance with a preferred embodiment of the present invention.

### DESCRIPTION OF THE PREFERRED EMBODIMENTS

A numeric and hierarchical knowledge classification system, (e.g., the Dewey Decimal Classification (DDC)), which defines concepts, is used for universal annotation. For example, game (DDC=799) relates to Fishing, hunting & shooting, and game (DDC=794.105) relates to chess. The universal annotation may be combined with human-aided machine translation, so individuals can tag their documents and control their meanings in other languages. They know that “game” as DDC=794.105 relates to chess, universally, so they can control how “game” will be translated to other languages. Multilingual communication, by e-mails, forums, blogs, Wikipedia and the like may proceed, with each participant working in his tongue and tagging his writing with universal concepts, while others see it in their tongues. Moreover, a Universal System of Expression (USE) may be generated by employing (1) a vector format for conjugating the numeric concepts by function, case, gender, person, tense, and the like, to create word-like numeric entities, of substantially singular sense; and (2) a syntax code of operators, defining syntactic relations. For example 0,1,1,3,1,1,1,1 X 794.105,2,1,3,1,1,1,1 : 794.105,1,2,3,0,1,0,3 means “He played chess,” and 0,1,1,3,1,1,1,1 X 799, 2,1,3,1,1,1,1 : 799,1,2,3,0,1,0,2 means “He hunted game.” Documents in USE may be accessible for fully automatic translation to a plurality of languages, on demand, and libraries of USE documents may be formed. USE documents may be generated as byproducts of human-aided machine translations between any two natural languages that recognize USE.

The principles and operation of the universal language according to the present invention may be better understood with reference to the drawings and accompanying descriptions. But it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

### Words and Senses—The Fluid and the Discrete

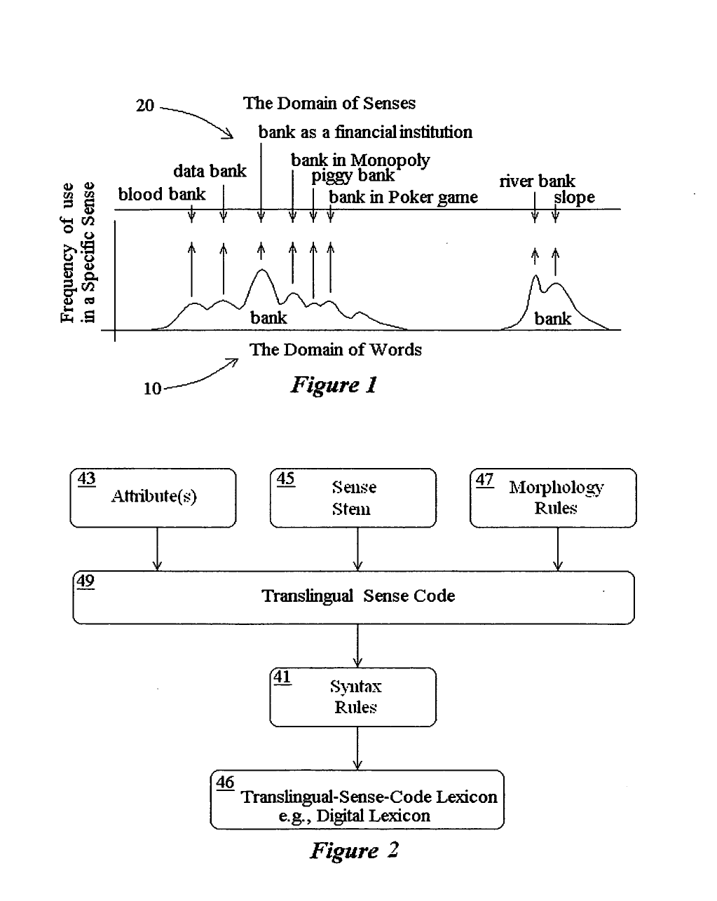

Reference is now made to FIG. 1, which schematically illustrates a domain of senses and a domain of words, as defined by the present invention. Senses may be regarded as discrete entities, but words, the tools we use to relate to them, are fluid, with a spread of senses about each word, the senses spilling over and mingling with others. Humans have invented words to express senses, which seem to be somehow registered in their minds and reachable by multiple associations. In fact, it may be that the very spread in senses to a word provides the associations, that allows us to reach a specific sense register we seek.

In consequence, the relationship between words and senses is such that one can generally find a proper word to describe a specific sense. But expressing words in terms of all their senses is a challenging and nearly impossible task.

FIG. 1 illustrates this, for example, in reference to the word, “bank,” which has a first “sense spread” about it, relating to holding reserves, and a second, relating to natural slopes. Although many discrete senses can be noted, for example, data bank, blood bank, piggy bank, and others, it is clear that many other senses may exist, or may be constructed and understood. Yet, delineating all of them is unlikely. There will probably be many senses that will be overlooked.

FIG. 1 introduces a domain of words 10 and a domain of senses 20, and it is suggested here that they are very different in nature:

The domain of words 10 is a domain of fluid entities, and it may not be possible to describe a given word by all its senses.

The domain of senses 20, on the other hand, is a domain of discrete entities, and any given sense can be matched with words that describe it.

Thus, the success of the description depends on the vantage point: are we in the domain of words, looking across, at senses, or are we in the domain of senses, looking across, at words.

### Construction of a Translingual-Sense-Code Lexicon

### Defining a Sense Stem

The present invention introduces a new concept—a sense stem, analogous to a word stem. Yet, for the sake of clarity, a few definitions are offered:

a word, as referred to here, relates to speech sounds or a portion of text, which form a unit that communicates one or several meanings, the unit not being divisible into smaller units that communicate meanings. Each meaning is associated with a function, for example, a noun, a verb, a preposition, a conjunction. Additionally, each meaning may be associated with other attributes, such as case, gender, number, tense, person, mood, voice and others. For example, the word “sorter” may be a noun representing a human, or a noun representing an inanimate object.

a word stem, as referred to here, relates to the part of a word that remains substantially unchanged upon inflection. The stem has no function, as such, but is associated with the meanings of the inflected forms. For example, a stem “driv” is associated, among others, with driver and driving, in the following:
1. a driver, as a mechanical element for imparting motion to a second element, the first element driving the second piece into place;
2. a driver, as a person driving a motor vehicle; and
3. a driver, as an electronic circuit or software element that supplies input, driving another electronic circuit.

a sense, as referred to here, relates to a single meaning of a word or phrase. A sense must be associated with a function, and possibly with other attributes. The sense stem, function and other attributes, together, define the single, specific meaning.

a sense stem, is a new concept, introduced by the present embodiments. It is analogous to a word stem, and like the word stem, it has no function of its own but is associated with the functions of the inflected forms. It is different from a word stem in that it relates to a single sense. In other words, the sense stem for “driv,” as associated with a driver—a person driving a motor vehicle is subtly but distinctly different from the sense stem for “driv,” as associated with a driver—an electronic circuit that supplies input, driving another electronic circuit.

### Components of the Translingual-Sense-Code Lexicon

Reference is now made to FIG. 2, which schematically illustrates the construction of a translingual sense code 49 and a translingual-sense-code lexicon 46, in accordance with preferred embodiments of the present invention. Certain definitions are required:

The Sense stem 45: the sense stem 45 is a portion of the translingual sense code 49, which is independent of function and other attributes, and which remains unchanged upon inflection. On it own, the sense stem 45, analogous to the word stem “driv” does not have a specific meaning.

In accordance with a preferred embodiment of the present invention, the sense stem 45 is a natural number. Examples of a sense stem may be 02300 or 327.

The Attribute 43: the attribute 43 or attributes 43 are the portions of the translingual sense code 49, which are expressed by inflection, and which include at least a function, e.g., noun, verb, adjective, and the like, and preferably, additional features, such as case, gender, number, tense, person, mood, voice and the like. When a sense stem is inflected in accordance with its attributes, it has a specific meaning.

In accordance with a preferred embodiment of the present invention, the attributes 43 are described as natural numbers, and inflection is defined by the morphology rules, below.

The Morphology Rules 47: The morphology rules 47 define how a sense stem is to be inflected so as to express various attributes. It is a system for combining the sense stem 45 and the attributes 43, to form the translingual sense code 49.

In accordance with a preferred embodiment of the present invention, the sense stem 45 and each of the attributes 43 are described as natural numbers, while the morphology rules 47 define the order of these in a vector of n natural numbers, A(1), A(2) . . . A(n). The morphology rule may define the sense stem as the first position, A(1), the function as the second position, A(2), and so on.

The Translingual Sense Code 49: The translingual sense code 49 is an unequivocal word equivalent, formed of a sense stem 45, inflected to express specific attributes 43, in accordance with the morphology rules 47.

In accordance with a preferred embodiment of the present invention, the translingual sense code 49 is a vector of n natural numbers, for example, A(1), A(2) . . . A(n). A specific example of a translingual sense code 49 may be 04110,1,3,1,0,0,0,1, which in Example 2 below, means, a human sorter—a person who sorts things.

Syntax Rules 41: The syntax rules 41 specify how the unequivocal word equivalents of the translingual sense codes 49 are joined to form phrases, clauses and sentences.

In accordance with one embodiment of the present invention, the syntax rules 41 may be a predetermined order of arranging the vectors of natural numbers, using common punctuation marks, to form phrases, clauses and sentences.

In accordance with a preferred embodiment of the present invention, the syntax rules 41 are numerical operators, for example, +, X, :, *, ( ), and others, which define relations between the vectors of natural numbers, to form phrases, clauses and sentences.

The Translingual-Sense-Code Lexicon 46: The translingual-sense-code lexicon 46 is an unequivocal, written language, also referred to as a universal language, in which sense stems 45, are combined with various attributes 43, through the morphology rules 47, to form unequivocal words or translingual sense codes 49, and these are combined via syntax rules 41, to form the form phrases, clauses and sentences.

The translingual-sense-code lexicon 46 may be used as a translation-ready format, from which translation to any language may be automatic. Additionally, it may also be used for information retrieval and data acquisition, and as an aide in language acquisition. It may further be used for tagging, for word sense disambiguation.

The translingual-sense-code lexicon 46 as described herein is generative, as it can create unequivocal word equivalents, by combining sense stems and attributes, which may not exist in any language. As such, it may be of relevance in discussions of The Generative Lexicon, Pustejovsky (1995), Bouillon & Busa, (eds.) (2001).

### Extracting the Sense Stem

There remains the question of how the sense stem 45 is to be extracted.

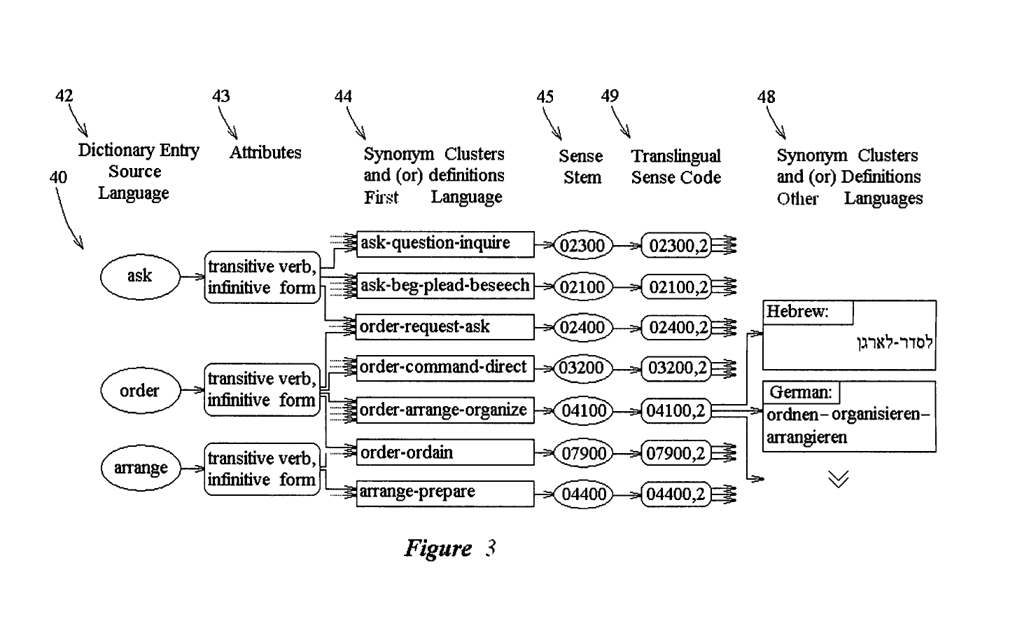

Reference is now made to FIG. 3, which illustrates a mapping 40 of English dictionary entries 42, which may be words, phrases, or idioms, into the translingual sense code 49, for extracting sense stems 45, in accordance with preferred embodiments of the present invention. The dictionary entries 42 may be grouped into synonym clusters 44, and (or) provided with definitions.

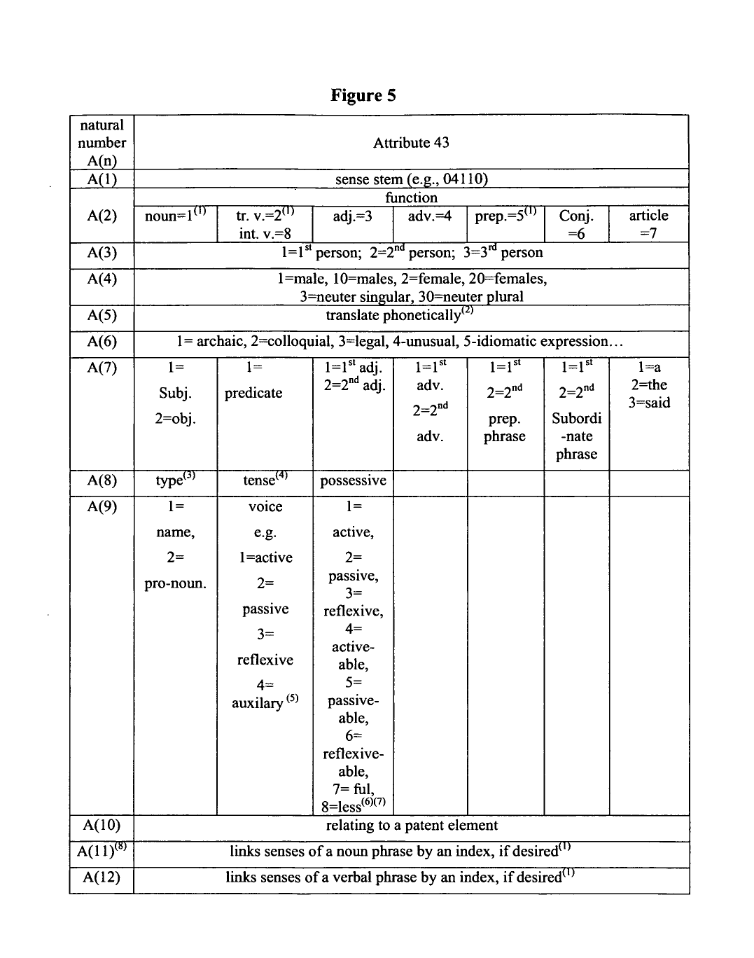

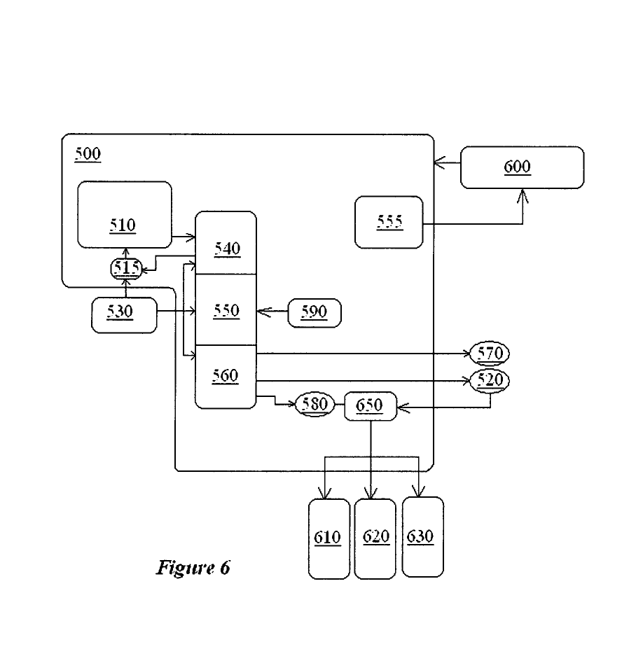

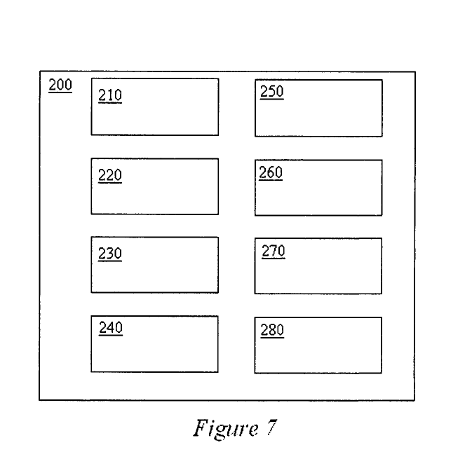

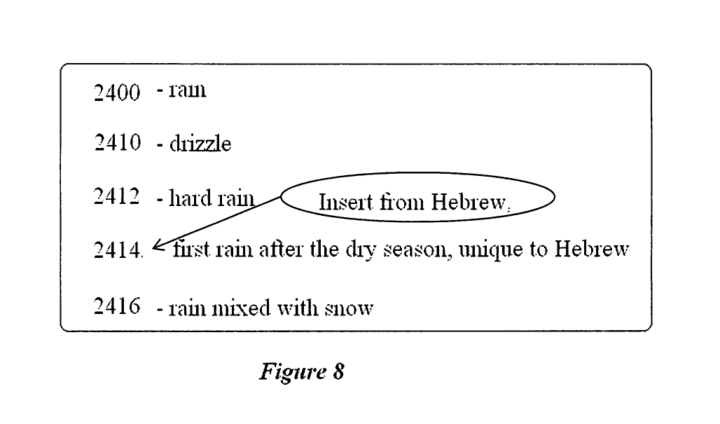

Additionally, each dictionary entry 42 is noted for its attribute 43, such as function, person, number and the like. The senses are described as the translingual sense code 49, preferably of natural numbers, for example, where A(1) denotes the sense stem 45, and A(2)-A(n) denote the other attribute 43. In the example of FIG. 3, the dictionary entries are transitive verbs in the infinitive forms, so A(2)=2 (See FIG. 5, hereinbelow), and the sense is described as the translingual sense code 49 of A(1), A(2).

The translingual sense code 49, describing the senses, is preferably linked to synonym clusters 48 and (or) definitions, in other languages, to form the translingual system. For example, the word “order” as a transitive verb, in the infinitive form, may be clustered with “arrange” and “organize,” assigned the natural number 04100 as the sense stem 45, so that the translingual sense code 49 is 04100,2 and linked to synonym clusters 48 in Hebrew and German, of substantially the same sense. Naturally, other languages may be included as well.

It will be appreciated that monolingual definitions may be used, in place of, or in additional to the synonym clusters, for example, “to order—to put into a methodical arrangement.” The monolingual definitions may be based on various relationships, for example, goose—a large waterfowl, intermediate between swans and ducks, or a gander—an adult male goose, and other relationships, as known.

Phrases and idioms may be grouped into synonym clusters, in the same manner as words, for example, the idiom “sleep on it” may be defined by another idiom, “think it over” and (or) by the words “consider,” and “reflect.”

FIG. 3 is a representation of the domain of words 10 of FIG. 1, hereinabove.

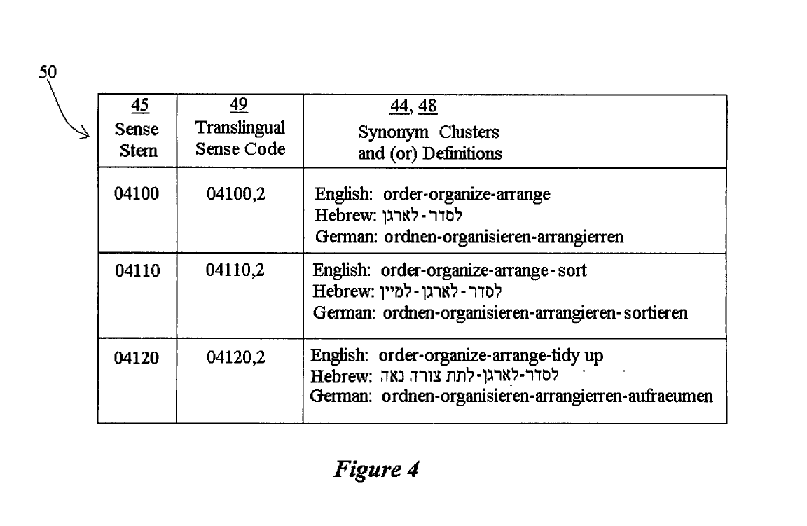

Reference is now made to FIG. 4, which is a transformation of FIG. 3, to the domain of senses 20 of FIG. 1, in accordance with preferred embodiments of the present invention.

FIG. 4, illustrates a transform from the domain of words 10 to the domain of senses 20, in accordance with an embodiment of the present invention. FIG. 4 is arranged by the sense stems 45 and the translingual sense code 49, describing the senses, linked to their associated synonym clusters and (or) definitions 44 and 48 of all of various languages, for example, English, Hebrew, and German.

FIG. 4 represents a translingual sense dictionary 50, and brings the senses out into the open, coded in a language-independent, manner, preferably, digitally, so as to replace the multiple-association register of the mind, illustrated in FIG. 1 with the unequivocal, translingual sense code 49.

As a matter of definition, each single sense of the translingual sense code 49 may also be referred to as a translingual-sense-code entry.

### EXAMPLES

Additional objects, advantages, and novel features of the present invention will become apparent to one ordinarily skilled in the art upon examination of the following examples, which are not intended to be limiting. Additionally, each of the various embodiments and aspects of the present invention as delineated hereinabove and as claimed in the claims section below finds experimental support in the following examples.

Reference is now made to the following examples, which together with the above descriptions, illustrate the invention in a non limiting fashion.

### Example 1

### The Translingual-Sense-Code 49 as a Vectors of Natural Numbers

Referring is now made to FIG. 5, which illustrates a system for expressing the translingual sense code 49 in digital format, using vectors of “n” natural numbers, A(1), A(2) . . . A(n), in accordance with an embodiment of the present invention. Each number “n” is expansible, as necessary, being of a single digit, double digits, and so on.

According to the present example:
the first position A(1) defines the sense stem 45;
the second position A(2) defines the function, so A(2)=1, inflects the sense stem to mean a noun of the specific sense, and so on;
the third position A(3) defines the person, so A(3)=1, inflects the sense stem to express first person. Note, that in some languages, this inflection applies only for pronouns, in others, it applies to verbs; and still in others, to verbs, adjectives, and even prepositions. The person inflection in the translingual sense code 49 is made available, regardless of function, for languages that require it, and it may be ignored by languages that do not require it.
the fourth position A(4) distinguishes between male, female, and neuter, in the singular and plural forms. Again, it is made available, regardless of function, for languages that require it, and it may be ignored by languages that do not require it.
the fifth position A(5) is used to indicate that a phonetic translation is required, for example, for a name. In some cases, the entry of the fifth position is of the phonetic translation, in accordance with phonetic symbols, for example as described in comment 2, below. Note, in this instance, there will be no sense stem. The town name Chelmsford, may be expressed, for example, as follows: A(1)=0, A(2)=1, A(3)=3, A(4)=3, A(5)=ch\check{e}lmz′f [symbol] rd, or, 0,1,3,3, ch\check{e}lmz′f [symbol] rd. It will be appreciated that a universal system for pronunciations, as suggested in comment 2 hereinbelow, is preferred.
the sixth position A(6) indicates the word may be colloquial, legal, or otherwise unusual.
the seventh position, A(7), expresses the case, when the function A(2) is a noun, indicates if the predicate, when the function A(2) is a verb, and so on.

Other values are similarly apparent from FIG. 5.

The following comments relate to the superscripts of FIG. 5:

1. Noun phrases and verb phrases may be linked, using A(11) or A(12).

2. A digital phonetic code, which includes all the sounds and vowels of all the languages is required, for phonetic translations, such as of names. New sounds need to be introduced to each language to cover these, in a systematic manner. For example, kh may be defined in English for the Spanish “J”. When A(5) includes the digital phonetic code, the word will be translated phonetically, using the target-language alphabet, with a full set of sounds.

3. Noun types may relate to: 1=human, 2=animal, 3=plant, 4=object, 5=abstract, 6=action, 7=place, 8=time, and others.

4. A basic tense structure of: 0=infinitive, 1=past, 2=present; 3=future, and 4=imperative, may be used. Alternatively, an expansible system, which describes the particular tenses of a specific language, may be used, for example, noting the language as the first digit, and the tenses with the other digits. For example, let English be denoted by the first digit “1”, and the English tenses described as 11=Eng, past simple, 111=Eng, past perfect, 1101=Eng, past continuous, 1111=Eng, past perfect continuous, 12=Eng, present simple, 121=Eng, present perfect, 1201=Eng, present continuous, 1211=Eng, present perfect continuous, and so on.

5. An expansible system may be used to denote affirmative, negative, interrogative, and negative interrogative (e.g., did you not . . . ).

6. An active adjective may relate to washing, as in a washing machine, a passive adjective may relate to washed, as in washed clothes, a reflexive adjective may relate to sleeping, as in a sleeping man, an active-able adjective may relate to one or that, which is cable of washing, a passive-able adjective may relate to one or that, which can be washed, and a reflexive-able adjective may relate to one who is cable of self-washing (i.e., self cleaning). Naturally, other forms may also be defined.

7. Where the translingual sense code 49 represents a sense with attributes that do not exist, within a single word or term, in certain languages, definitions or phrases, based on the attributes may be produced by the operating utility, in those languages.

8. The linking indices, of A(11)-A(12) serve to overcome different syntax order in different languages. They form chains, which retain their meanings even as the order of words change from one language to another. For example, in “I wish to go by-car, to-the-cinema,” and “I wish by-car, to-the-cinema go,” the prepositional phrases are linked, and will remain so in the different languages, in spite of the different order. Similarly, the order of noun-adjective, or adjective-noun, is unimportant, as the nouns and adjectives are marked by their functions and linked by A(11).

9. The translingual sense code need be described only to the last non-zero term, e.g., if the last non-zero term is A(8) it need have only 8 natural numbers.

In a way, the translingual sense code 49 operates as a checklist for verifying that all information relevant to the decision making of the operating utility will be available. In general, the translingual sense code 49 may be formed automatically, by the operating utility. But where information is lacking, human input is sought.

It will be appreciated that another coding system, based on the Latin alphabet, the Greek alphabet, Roman numerals, real numbers, or another system as known, may be used. For example, with Latin letters, a sense stem 04110 could be represented as TjKn and a complete translingual sense code may be expressed, for example, as “TjKn,I,l,ee,w.” The advantage of natural numbers is that they are thrifty in terms of digital storage space, since they do not require conversion to ASCII.

Additionally, the vector of natural numbers may include any number of natural numbers, so n may be 9 or 15. While it is advantageous for n to be 8, 16, or any other number, which can be expressed as 2 to some factor, that is not necessary.

It will be appreciated that many other tables may be created, for systematically defining attributes and possibly also linkages between terms.

### Example 2

The manner of generating the translingual sense code 49, for example, using FIG. 5, is illustrated in reference to the paragraph below:

“Sam was a sorter. He sorted files for a living. But the sorted files got to him. He was tired of sorting. So he bought a sorting machine to sort his files. And he promised himself that he would never sort files again.”

Letting a natural number 04110 represent the sense stem 45, as relating to sorting—arranging according to characteristics, the following constructions can be made:

1. sorter in “Sam was a sorter”

In accordance with the preferred embodiment of the present invention, the translingual sense code 49 that forms the unequivocal word equivalent for a human sorter, as in “Sam was a sorter,” may be constructed in accordance with the definitions of FIG. 5, as follows:
A(1) denotes the sense stem, for example, 04110;
A(2) denotes a noun;
A(3) denotes 3^{rd} person;
A(4) denotes male;
A(8) denotes human;

sorter=04110,1,3,1,0,0,0,1.

2. sorted, in “He sorted files for a living”
A(1) denotes the sense stem, 04110;
A(2) denotes a transitive verb;
A(3) denotes 3^{rd} person;
A(4) denotes male;
A(7) denotes predicate;
A(8) denotes past tense;
A(9) denotes: active;

sorted=04110,2,3,1,0,0,1,1,1.

3. sorted in “But the sorted files got to him”
A(1) denotes the sense stem, 04110;
A(2) denotes adjective;
A(3) denotes 3^{rd} person;
A(4) denotes male;
A(7) denotes first adjective;
A(9) denotes adjective in a passive form;

sorted=04110,3,3,1,0,0,1,0,2.

Although “sorted,” as an adjective, does not appear in most English dictionaries, the sense morphology 47 enables one to generate a meaning for “sorted” as an adjective, by combining the in-context sense stem of A(1) with the in-context function of A(2), making it possible to create senses as necessary and as relevant. Similarly, attributive nouns, for example, “city,” in city lights, or “health,” in health care, will be assigned an adjective function, which is their in-context function. With the sense morphology 47, all nouns can be verbed, and anything can be described adverbially.

The sense morphology 47 makes it possible to clearly distinguish between senses of different attributes, for example:

| | |
|---|---|
| noun: a human sorter: | 04110, 1, 3, 1, 0, 0, 0, 1; |
| noun: a machine sorter: | 04110, 1, 3, 1, 0, 0, 0, 4; |
| noun: an action, sorting: | 04110, 1, 3, 1, 0, 0, 0, 6; |
| adjective: sorted (e.g. sorted files): | 04110, 3, 3, 1, 0, 0, 1, 0, 2; |
| adjective: sorting (e.g. a sorting machine): | 04110, 3, 3, 1, 0, 0, 1, 0, 1; |
| adjective: capable of being sorted: | 04110, 3, 3, 1, 0, 0, 1, 0, 5; |
| adjective: capable of sorting: | 04110, 3, 3, 1, 0, 0, 1, 0, 4; |
| a transitive verb: to sort: | 04110, 2. |

As another example, letting a natural number 05230 be the sense stem 45, as relating to washing—cleansing by wetting thoroughly with water, to carry off foreign matter, the following senses can be constructed:

| | |
|---|---|
| adjective: capable of being washed | 05230, 3, 3, 1, 0, 0, 1, 0, 4; |
| (washable) | |
| adjective: capable of washing (washingable): | 05230, 3, 3, 1, 0, 0, 1, 0, 3; |
| adjective: capable of self-wash | 05230, 3, 3, 1, 0, 0, 1, 0, 5; |
| (selfwashable): | |
| a transitive verb, to wash (e.g., clothes): | 05230, 2; |
| an intransitive verb, to wash (oneself): | 05230, 8. |

As it happens, some of these senses do not have specific words or terms in some languages. For example, in English, there is no specific word or term for “capable of washing,” or for “capable of self-wash,” But the translingual sense code 49 provides these meanings nonetheless, and it is in this sense that it is generative. Upon translation to natural languages, where no equivalent term is available, a definition may be used.

### Example 3

### Syntax Rules, in Accordance with a First Embodiment

Given that the translingual sense code 49 are unequivocal word equivalents, they may be combined to form phrases and sentences, using any known syntax rules, for example, those of the English languages.

Accepting the order: subject, predicate, direct object, as syntax rules 41, the sentence, “He sorted files,” can be expressed by the translingual-sense-code lexicon 46, and specifically, by the digital lexicon 46, as follows:

“He” “He” needs no sense stem, being defined by the other attributes.

“sorted” The transitive verb “sorted,” in the past tense, has been described in the second example of digital sense morphology, above.

“files” Let the natural number for the sense stem 45 associated with “file—a collection of papers arranged in a folder,” be 06750.

Thus, “He sorted files” =

= 0,1,3,1,0,0,1,1,2 04110,2,3,1,0,0,1,1,1 06750,1,3,30,0,0,0,4.

### Example 4

### Syntax Rules, in Accordance with a Preferred Embodiment

In accordance with the preferred embodiment, numerical operators are used to define syntax rules, for example, as follows:
A relationship between subject and predicate may be expressed by X,

Example: “he works” may be expressed, for example, as “he X works,” or as “works X he.”

Wherein: the subject and predicate remain juxtaposed, but their order is unimportant.
A relationship specifying equivalence may be expressed by =,

Example: “they are friends” may be expressed, for example, as “they X are = friends,” or as “friends = they X are.” or as “friends = are X they.”

Wherein: the subject and predicate remain juxtaposed, but their order is unimportant.
A relationship between subject-predicate combination and an object may be expressed by ::,

Example: “he took it” may be expressed, for example, as “he X took :: it,” or as “took X he :: it,” or as “it :: he X took,” and even as “it :: took X he.”

Wherein: the subject and predicate remain juxtaposed, but their order is unimportant.
A relationship between an object and a verb may also be expressed by X,

Example: “he saw me come” may be expressed, for example, as “he X saw :: me X come,” or as “me X come :: he X saw,” or as “come X me :: he X saw,” or as “come X me :: saw X he,” or by other similar combinations.

Wherein: the subject and predicate remain juxtaposed, and the object and its associated verb remain juxtaposed, but the order is unimportant.
A relationship between an adjective and a noun may be expressed by *,

Example: “good book” may be expressed, for example, as “good*book,” or as “book*good.”

Example: “it is late” may be expressed, for example, as “it X is * late,” or as “late * it X is,” or as “late * is X it.”
A relationship between an adverb and a verb may be expressed by #,

Example: “She sang beautifully” may be expressed, for example, as “she X sang # beautifully,” or as “beautifully # she X sang,” or as “beautifully # sang X she,” or as or as “sang X she # beautifully.”

Wherein: the subject and predicate remain juxtaposed, but their order is unimportant. Thus, the system of the present example does not allow “sang # beautifully X she,” requiring that the subject-predicate combination take precedence over other combinations. It will be appreciated that other syntax systems may be devised, with different restrictions, provided they are consistent, throughout.
A relationship between an adverb and an adjective may be expressed by #,

Example: “highly useful remark” may be expressed, for example, as “highly # useful * remark,” or as “useful # highly * remark,”

Wherein: in accordance with the present example, the adverb-adjective combination takes precedence over the adjective-noun combination. It will be appreciated that a syntax system with an opposite rule is similarly possible, provided the rules are consistent, throughout.
A relationship between an adverb and a clause may also be expressed by #, the clause being in parenthesis,

Example: “however, it is late” may be expressed, for example, as “however # (it X is * late),” or as “(it X is * late) # however.”

Wherein: in accordance with the present example, the adverb modifying a whole clause may not be inserted in the middle of the clause, so that “it X is # however * late,” is not acceptable in accordance with the present example, as it creates a confusion regarding what specifically “late” relates to. It will be appreciated that other syntax systems with different rules may be applied. It is thus noted that in accordance with the present example, punctuation marks within a sentence, for example, commas and semicolons may be replaced by the parenthesis.
A relationship between a group of adjectives may be expressed by +, the group being in parenthesis,

Example: “good, enjoyable book” may be expressed, for example, as “(good + enjoyable) * book,” or as “(enjoyable + good) * book,” or as “book * (enjoyable + good),” or as “book * (good + enjoyable).”

Wherein: in accordance with the present example, the group of adjectives are not broken up, so that “enjoyable * book * good” is not accepted under the present system. It will be appreciated that other syntax systems with different rules may be applied.
A relationship between a group of adverbs may be expressed by +, the group being in parenthesis,

Example: “she sang beautifully, melodically” may be expressed, for example, as “she X sang # (beautifully + melodically),” or as “(beautifully + melodically) # sang X she,” or as a similar combination.

Wherein: in accordance with the present example, the subject and predicate remain juxtaposed and so is the group of adverbs. It will be appreciated that other syntax systems with different rules may be applied.
A relationship between a group of nouns may be EXPRESSED by +, the group being in parenthesis,

Example: “Dan and Jim left” may be expressed, for example, as “(Dan + Jim) X left,” or as “left X (Jim + Dan),” or as a similar combination.

Wherein: in accordance with the present example, the group of nouns remain together, in parenthesis. It will be appreciated that other syntax systems with different rules may be applied.
A relationship between a group of verbs may be expressed by +, the group being in parenthesis,

Example: “they ate and slept” may be expressed, for example, as “they X (ate + slept),” or as “(slept and ate) X they.”

Wherein: in accordance with the present example, the group of verbs remain together, in parenthesis. It will be appreciated that other syntax systems with different rules may be applied.
A relationship between a conjunction and a clause may be expressed, for example, as ̂, and the clause may be in parenthesis.

Example: “while they slept soundly . . . ” may be expressed as “while ̂ (they X slept # soundly) . . . ,” or as “while ̂ (soundly # they X slept),” or as “(soundly # they X slept) ̂ while . . . ,” or to similar combinations.

Wherein: in accordance with the present example, “while” relates to the time they slept soundly, regardless of its position. It will be appreciated that other syntax systems with different rules may be applied.
A relationship between a main clause and a subordinate close may be expressed, for example, as /,

Example: “while they slept soundly, she cleaned” may be expressed, for example, as “while ̂(they X slept # soundly)/ she X cleaned,” or as “(they X slept # soundly) ̂ while/she X cleaned,” or as “she X cleaned/while ̂(they X slept # soundly)” or as “she X cleaned/(they X slept # soundly) ̂ while,” or as similar combinations.

Wherein: in accordance with the present example, “while” relates to the time they slept soundly, and the clause “while they slept soundly” remains the subordinate clause, regardless of the order of the two clauses. It will be appreciated that other syntax systems with different rules may be applied.
A relationship between the components of noun phrases and noun clauses, as well as verb phrases may be maintained by square brackets, [ ],

Example: “that it is true was shown experimentally” may be expressed, for example, as “[that ̂ (it X is = true)] X [was shown] # experimentally,” or as “experimentally # [that ̂ (it X is = true)] X [was shown], or as “experimentally # [was shown] X [that ̂ (it X is = true)],” or as “[was shown] X [that ̂ (it X is = true)] # experimentally.”

Wherein: the subject and predicate remain juxtaposed, even when each is a phrase or a clause, but their order is unimportant.
It will be appreciated that while some punctuations, such as commas and semicolons may be replaced by the suggested syntax operators, others may remain, for example, periods may be used to end sentences.
The original document may include numbers and symbols, mathematical expressions, and other expression, for example, “These apples cost $2.08 per pound.” In order to avoid confusion between the system in accordance with embodiments of the present invention and the numbers and symbols, mathematical expressions, and other expression may be enveloped by a distinguishing mark, employing a symbol which is rarely used, for example, ///, or ++, for example:

“These apples cost ///$2.08/// per pound.”
It will be appreciated that many other operators and combinations of operators are similarly possible.

### Example 5

### Syntax Operators with the Translingual Sense Code 49

In accordance with the preferred embodiment, using operators for expressing syntactic relations, the sentence of Example 3, “He sorted files,” may be expressed as:

0,1,3,1,0,0,1,1,2 X 04110,2,3,1,0,0,1,1,1 :: 06750,1,3,30,0,0,0,4.

### Example 6

### Translation Ready Format

Embodiments of the present invention may be employed for providing translation ready formats, which are substantially unequivocal, for automatic translation to a plurality of languages. For example, a computerized system may be employed, containing a set of instructions, for

receiving a natural source language, including words and syntax rules; and

parsing the natural language, based on the syntax rules; and

converting the words to senses, based on a data base including a plurality of senses, wherein, each sense is contained in a sense expression, free from association with any natural language; and

re-writing the natural source language as a universal language.

Additionally, interactive human input may be employed for converting the words to senses, either by making a better selection from the data base, or independently of the data base, and possibly also for parsing.

Furthermore, the computerized system may be employed for translating the universal language to any natural language, automatically.

As such, the universal language, which is preferably digital, as described, becomes a translation-ready format for storing information, easily converted to any natural language, on demand.

Reference is now made to FIG. 6, which schematically illustrates a computerized system 500, for language disambiguation for a plurality of natural languages, in accordance with a preferred embodiment of the present invention. The computerized system 500 includes:

a sense data base 510, which comprises:
a plurality of senses, wherein:
   each sense is contained in a sense expression, free from association with any natural language; and
   the sense expression includes at least two components, a first component, specifying a sense stem, and a second component, specifying a function; and
a definition, in at least one of the plurality of natural languages, for each sense.

Additionally, the sense expression may include additional components, for specifying additional sense attributes.

Furthermore, the sense expression may be formed as a vector of n numbers, each representing one of the portions.

Additionally, the data base 510 may include at least two definitions for any one of the senses, each of the at least two definitions being in a different one of the plurality of natural languages.

Furthermore, the plurality of senses form substantially unequivocal word equivalents, therefrom to formulate a universal language 580 for the plurality of natural languages.

Additionally, the computerized system 500 may include a tagging unit 520 for allowing automatic tagging of words of any one of the plurality of natural languages with selected ones of the senses, thereby to provide word sense disambiguation for the tagged natural language.

Furthermore, the computerized system 500 may include an interactive human input unit 530 with the tagging unit 520, for overriding the automatic tagging and for providing human tagging.

Additionally, the human input may include human selection from the data base 510.

Alternatively, the human input may include input which is not available in the data base 510.

Additionally, the computerized system 500 may include a database update unit 515, for updating the data base 510 to include the human input.

Furthermore, the tagging may be used to aid students of the tagged language as a foreign language, for providing meanings in context, for example, as taught in commonly owned U.S. patent application Ser. No. 10/750,907, whose disclosure is incorporated herein by reference.

Additionally, in accordance with a first translation embodiment, the computerized system 500 may include an automatic translation unit 650 configured to make use of the tag in order to find a translation of a word from a first one of the plurality of natural languages to a second one of the plurality of natural languages.

Furthermore, the computerized system 500 may include a search query input 570, for input of a search query including a word in a first one of the plurality of natural languages, and further configured with the tagging unit 520 to tag the word with a respective sense and being associated with a search engine, the search query input 570 being configured to submit the sense for information retrieval from the search engine, thereby to allow information retrieval in at least one other of the plurality of natural languages.

Additionally, the computerized system 500 may include:

an expression unit 540 for automatically expressing an input 600, in a first of the plurality of natural languages as a series of senses;

a syntax unit 550 for employing syntax rules, to automatically define relationships between the senses; and

a universal language unit 560 for automatically combining the senses in accordance with the syntax rules, thus re-writing the input 600 in a universal language 580, which is substantially equivalent to the input 600, thereby to provide written expressions, such as phrases, clauses, sentences, and whole documents, in a substantially unequivocal manner and free from association with a specific natural language.

Furthermore, the computerized system 500 may employ the interactive human input unit 530 with the expression unit 540, for overriding the automatic expressing and for providing human expressing.

Furthermore, the computerized system 500 may employ the interactive human input unit 530 with the syntax unit 550, for overriding the automatic definition of relationships between the senses and for providing human definition of relationships between the senses.

Additionally, the syntax unit 550 may be configured to describe syntax rules as syntax operators, expressed by symbols.

Thus, the phrases, clauses, and sentences of the universal language 580 may comprise the senses as vectors of natural numbers, the senses being combined by the syntax operators.

Additionally, the syntax unit 550 may comprise a symbol design unit 590 to provide newly designed symbols for the syntax operators, thereby to avoid conflict with the commonly accepted meanings of existing symbols.

Furthermore, the computerized system 500 may include a distinguishing unit 555, for:

scanning the input 600 in the first of the plurality of natural languages for original numbers and symbols and for mathematical expressions and other expressions, which use numbers and symbols, and

enveloping the original numbers, symbols, mathematical expressions, and other expressions, by a distinguishing mark, to distinguish them from numbers and symbols of the universal language 580.

Additionally, the computerized system 500 may employ the interactive human input unit 530 with the universal language unit 560, for overriding the automatic combining of the senses in accordance with the syntax rules and for providing human combining.

In accordance with the preferred translation embodiment, the computerized system 500 may include the automatic translation unit 650 for translating the universal language 580 to a target natural language 610.

Further in accordance with the preferred translation embodiment, the automatic translation unit 650 may be employed for translating the universal language 580 to a plurality of target natural languages, such as target natural language 610, target natural language 620, and target natural language 630.

In accordance with another aspect of the present invention, there is thus provided an apparatus for providing natural language free expressions for inputs provided in any one of a plurality of natural languages, including:

an expression unit 540, for automatically expressing an input 600, in a first of the plurality of natural languages as a series of senses, each sense expressed in a manner free from association with a specific natural language, wherein each sense is associated with a definition, in at least one natural language;

a syntax unit 550 for providing symbols, as syntax operators, which describe syntax operations; and

a universal language unit 560 for combining at least two senses with at least one syntax operator, to form at least one written expression in a manner independent of specific association with any one of the plurality of natural languages.

It will be appreciated that in accordance with the present aspect, the senses need not be expressed as having two components.

In accordance with still another aspect of the present invention, there is thus provided an apparatus for freeing an input in one of a plurality of natural languages from syntax rules of the one natural language, including:

an input of at least two words, in the one natural language, combined by syntax rules of the one natural language, and associated with a meaning in the one natural language;

a syntax unit 550 for providing symbols, as syntax operators, which describe syntax operations; and

a universal syntax unit 550 for combining the at least two words with at least one syntax operator, to form at least one written expression, free of the syntax rules of the one natural language.

It will be appreciated that in accordance with the present aspect, the syntax unit 550 may be employed with words, rather then with senses.

### Employing Knowledge Classification Systems:

Knowledge classification systems are known. The Dewey Decimal Classification (DDC) organizes knowledge into classes and subclasses, in a numeric, hierarchical manner. For example, categories for “game” include:

1. 799—game as in “Fishing, hunting & shooting,” under “Arts & recreation>>Sports, games & entertainment”;

2. 796—game as in “Athletic & outdoor sports & games,” under “Arts & recreation>>Sports, games & entertainment”;

3. 795—game as in “Games of chance,” under “Arts & recreation>>Sports, games & entertainment”;

4. 794—game as in “Indoor games of skill,” under “Arts & recreation>>Sports, games & entertainment”;

5. 793—game as in “Indoor games & amusements,” under “Arts & recreation>>Sports, games & entertainment”; and

6. 179.8 game as in Deceit & mischief, under “Philosophy & psychology>>Ethics>>Other ethical norms.”

Although its original purpose was for library classification, the DDC may be employed for universal annotation:

1. “He likes games (DDC=179.8)” means “he is into mischief”; and

2. “He likes games (DDC=793)” means “he is into indoor games & amusements.”

Similarly, a river bank (DDC=551.483) can be differentiated from bank (DDC=332) as a financial institution.

Furthermore, as a system of taxonomy, the DDC provides general relations to other concepts, in a subtype-supertype hierarchy. Poker (795.412), child of games of chance (795), is cousin to chess (794.105), child of games of skill (794).

Other knowledge classification systems include the Universal Decimal Classification, the Library of Congress Classification, the Chinese Library Classification, and the like. The Gellish English Dictionary is knowledge classification system, designed as an electronic dictionary of concepts. It is arranged as taxonomy of subtype-supertype hierarchy, so each concept is defined as an explicit subtype of one or more supertype concepts.

As universal concept classifications are known, using them in Universal System of Expression which employs these systems is possible.

It is therefore proposed is to create a DDC-based Universal System of Expression, by:

1. creating numeric, word-like entities from DDC concepts, by employing a numeric vector of 2-16 elements, the first representing a DDC concept, and the others representing attributes: Taking 796—“Athletic & outdoor sports & games,” and employing the vector format to define function, case, gender, person, number, tense, and the like, we define:

i. 796,1—noun—an outdoor sports game;

ii. 796,2—transitive verb—playing an outdoor sports game;

iii. 796,2,1,3,1,1,1,1—transitive verb, male, third person, single, past tense, active form, predicate in a sentence—played, in “He played an outdoor sports game.”

The vector format allows terms with no DDC concept, for example pronouns, articles, and conjunctions. Thus:

i. 0,1,1,3,1,1,1,1—no DDC concept, noun, subject, 3rd person, male single, pronoun, human—he;

ii. 0,1,2,3,2,1,1,1—no DDC concept, noun, object, 3rd person, female, single, pronoun, human—her.

2. Creating a syntactic system, using symbols as syntactic operators, and defining a specific USE typology. For example, the noun-verb relationship may be described by “X” and the noun-verb group to direct object, by “:”, so that “He played ball” is “He X played : ball.” USE typology may be that the subject and predicate must be juxtaposed, in any order, and the direct object may be on either side of them, so that in USE only the following will be allowed:

“He X played: ball.” = “Ball: he X played.” = “Ball: played X he.” = “Played X he: ball.”

Employing existing DDC concepts, a wide range of universal expressions may be formed. For example:

“He played an outdoor sports game”:

0,1,1,3,1,1,1,1 X 796,2,1,3,1,1,1,1 : 796,1,2,3,0,1,0,3.

“He played chess”:

0,1,1,3,1,1,1,1 X 794.105, 2,1,3,1,1,1,1: 794.105, 1,2,3,0,1,0,3.

“He hunted game”:

0,1,1,3,1,1,1,1 X 799, 2,1,3,1,1,1,1: 799,1,2,3,0,1,0,2.

“He deceived her”:

0,1,1,3,1,1,1,1 X 179.8,2,1,3,1,1,1,1: 0,1,2,3,2,1,1,1.

It is further proposed to expand the DDC system to more concepts, forming a multilingual dictionary of concepts and numeric, word-like terms. For example, at present, 179.8—Philosophy & psychology>>Ethics>>Other ethical norms, lumps together bullying, mischief, deceits and the like. The expansion will distinguish amongst then, so that 179.81 will be bullying, 179.82 will be mischief, and so on. Preferably, the expansion will be carried out during the project to sufficient extent, that future progress by a Wiki system will be possible.

At the same time, some concepts may need to be combined. For example, the games chess, football and Poker are distinct, but in many languages, a single verb, to play, is used for the activity, while in others, specific verbs may be used. Thus a general concept of playing different types of games may be needed. This may be described, for example, by the verb: 793;794;795;796,2 indicating that for the activity, games 793-796 employ the same verb, in some languages. In others, the numeric term may be specific to game, also for the activity.

It is further proposed that the word-like numeric entities will be described in a multilingual sense dictionary, MSD, which will be constructed so as to have:

i. the word-like numeric entities,

ii. substantially equivalent definitions in each of the languages of the MSD, for each of the word-like numeric entities, so the meanings of the word-like numeric entities are clear and defined to speakers of any one of the languages of the MSD; and

iii. the appropriate expressions to replace the word-like numeric entities in each of the languages of the MSD. These expressions may be single words, terms or phrases, like fall asleep, come to, and the like, and groups of words, such as “indoor game of skill.” When using phrases or groups of words, it is important to mark the words of the group that are to be conjugated, for number, gender, and other attributes. For example, in the case of “indoor game of skill,” the plural is “indoor names of skill,” and indoor game is underlined. In French and Hebrew the adjective “indoor” will likewise be conjugated. The adjective phrase “of skill” is not conjugated. This way, one prevents a system where the plural of “indoor game of skill” becomes “indoor game of skills”

Preferably, the MSD will be divided into registers, such as coarse, fine, law, math.

There is thus provided, in accordance with an embodiment of the present invention a computerized system 200, configured for performing human-aided machine translation, the computerized system including:

an input unit 210, for providing an input in a first natural language;

a tagging unit 220, for providing a universal system of annotation, linked at least to the first natural language and a second natural language,

wherein by tagging the input in the first natural language with the universal system of annotation, an operator simultaneously defines meanings in both the first and the second natural languages, thus ensuring that his meaning in the first language is preserved in the second language.

Additionally, the universal system of annotation may be linked to a third natural language, and by tagging the input in the first natural language with the universal system of annotation, the operator simultaneously defines meanings in the three natural languages.

Furthermore, the computerized system 200 may be employed for multilingual communication.

Moreover, the multilingual communication may be selected from the group consisting of an e-mail, a blog, a forum, a “go to meeting” a Wikipedia, and an SMS, and other forms of communication as known.

Furthermore, the universal system of annotation may be based on a knowledge classification system.

Moreover, the universal system of annotation is a numeric and hierarchical knowledge classification system.

Furthermore, the universal system of annotation is based on the Dewey Decimal Classification (DDC) System of numeric concepts.

Furthermore, the universal system of annotation is based on an adaptation of the Dewey Decimal Classification (DDC) System, for universal annotation, by:

i. providing finer numeric concepts, for more specific definitions, where necessary; and

ii. coalescence of numeric concepts, for more general definitions, where necessary.

In this manner, one can ensure that senses from any language may be included, as illustrated, for example, in FIG. 8.

Additionally, the numeric concept may be associated with a vector format of at least two elements, a numeric concept element and a function element, for conjugating the numeric concept at least by function, to create word-like numeric entities.

Additionally, the word-like numeric entities may be used in multilingual searches, via a search unit 230.

Furthermore, the universal system of annotation is formed as a machine readable, multilingual sense dictionary (MSD) 240, which includes:

i. the word-like numeric entities;

ii. substantially identical definitions in at least two natural languages for the word-like numeric entities; and

iii. expressions for each of the word-like numeric entities in each of the at least two natural languages. The expressions may be words, phrases or groups of words.

It will be appreciated that 3 or more languages may be employed.

Additionally, the vector format may employ a plurality of elements, for conjugating the numeric concept by various attributes, such as case, gender, number, and the like. Specifically, the source langauge words may be indexed and the source language word index may be included in the vector format of the numeric word-like entity, for checking and correspondence.

It will be appreciated that synonyms may receive the same numeric word like entities. Alternatively, synonyms may receive the same numeric word like entities on coarse registers, and may be distinguished on finer registers.

Where the necessary expressions are formed as groups of words, the words in the group, which are to be conjugated in accordance with the various attributes indicated by the vector elements, are marked in the MSD, so as to allow replacing the word-like numeric entities with the expressions, correctly conjugated upon translation from the word-like numeric entities to any of the natural languages. For example, “indoor game of skill.”

Moreover, the computerized system 200 may be configured for providing a universal system of expression (USE), which is natural-language-free, the computerized system 200 including:

an expression unit 250, for expressing an input of a natural language, having at least two terms and a well defined syntactic relationship in the natural langauge, between the terms, as word-like numeric entities;

a syntax unit 260 for providing a syntactic code of syntax operators, for describing syntax operations; and

a universal system of expression unit 270 for combining the word-like numeric entities and the syntax operators, to form universal expressions, free of sense and syntax associations with any natural language.

Furthermore, the computerized system 200 may be configured for providing fully automatic ruled based machine translation from USE to the languages that are included in the MSD.

Moreover, the computerized system 200 may be configured for human aided translation via an interrogation unit 280, which performs general interrogation, even beyond what is necessary for any specific language (i.e., it asks about gender, even upon translation to English where gender is generally not an issue), so that USE document may be produced by the interrogation unit 280, as byproducts of human-aided machine translations between any two natural languages that are included in the MSD, for fully automatic ruled based machine translation from USE to other languages of the MSD.

Furthermore, the computerized system 200 may be employed in multilingual communication, using the MSD 240 and the numeric word-like entities.

There is thus also provided, in accordance with an embodiment of the present invention, a method for performing human-aided machine translation, including:

providing an input in a first natural language;

tagging the input in the first natural language with a universal system of annotation, linked at least to the first natural language and to a second natural language, thereby simultaneously defining meanings in both the first and the second natural languages, and ensuring that the meaning in the first language is preserved in the second language.

Moreover, the method further includes associating the numeric concept with a vector format of a plurality of elements: a numeric concept element, a function element, and elements for various attributes, for conjugating the numeric concept, by function and by attributes, to create word-like numeric entities, wherein the universal system of annotation is a machine readable, multilingual sense dictionary (MSD) 240 which includes:

i. the word-like numeric entities;

ii. substantially identical definitions in at least three natural languages for the word-like numeric entities; and

iii. expressions for each of the word-like numeric entities in each of the at least three natural languages,

wherein the expressions for each of the word-like numeric entities in each of the at least three natural languages are provided by translators to the at least three languages working together, simultaneously translating the word-like numeric entities to the at least three languages and simultaneously ensuring translation agreement amongst the at least three languages.

It will be appreciated that the simultaneous translation may be carried out for additional languages as well.

The importance of the method in accordance with the present embodiment is that the multilingual agreement is achieved by simultaneous translation to the different languages, with specific context at hand, so that the MSD learns in a manner that imitates the way a child learns a language, as opposed to rigorous fitting dictionary entries, unrelated to a specific context.

In accordance with another embodiment, there is provided an apparatus for freeing an input in one of a plurality of natural languages from syntax rules of the one natural language, including:

an input of at least two words, in the one natural language, combined by syntax rules of the one natural language, and associated with a meaning in the one natural language;

a syntax unit for providing symbols, as syntax operators, which describe syntax operations; and

a universal syntax unit for combining the at least two words with at least one syntax operator, to form at least one written expression, free of the syntax rules of the one natural language.

It will be appreciated that the computerized system 200 may be hand-held.

It is expected that during the life of this patent many relevant universal languages will be developed and the scope of the term universal language is intended to include all such new technologies a priori.

As used herein the term “substantially” refers to ±10%.

As used herein the term “about” refers to ±30%.

Additional objects, advantages, and novel features of the present invention will become apparent to one ordinarily skilled in the art upon examination of the following examples, which are not intended to be limiting. Additionally, each of the various embodiments and aspects of the present invention as delineated hereinabove and as claimed in the claims section below finds experimental support in the following examples.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A computerized system, configured for performing human-aided machine translation, the computerized system including:
an input unit, for providing an input in a first natural language;
a tagging unit, for providing a universal system of annotation, linked at least to the first natural language and a second natural language,
wherein by tagging the input in the first natural language with the universal system of annotation, an operator simultaneously defines meanings in both the first and the second natural languages, thus ensuring that his meaning in the first language is preserved in the second language.

2. The computerized system of claim 1, wherein the universal system of annotation is further linked to a third natural language, and by tagging the input in the first natural language with the universal system of annotation, the operator simultaneously defines meanings in the three natural languages.

3. The computerized system of claim 1, employed for multilingual communication.

4. The computerized system of claim 3, wherein the multilingual communication is selected from the group consisting of an e-mail, a blog, a forum, a “go to meeting” a Wikipedia, and an SMS.

5. The computerized system of claim 1, wherein the universal system of annotation is based on a knowledge classification system.

6. The computerized system of claim 1, wherein the universal system of annotation is a numeric and hierarchical knowledge classification system.

7. The computerized system of claim 1, wherein the universal system of annotation is based on the Dewey Decimal Classification (DDC) System of numeric concepts.

8. The computerized system of claim 7, wherein the universal system of annotation is based on an adaptation of the Dewey Decimal Classification (DDC) System, for universal annotation, by:
i. providing finer numeric concepts, for more specific definitions, where necessary; and
ii. coalescence of numeric concepts, for more general definitions, where necessary.

9. The computerized system of claim 8, and further including associating the numeric concept with a vector format of at least two elements, a numeric concept element and a function element, for conjugating the numeric concept at least by function, to create word-like numeric entities.

10. The computerized system of claim 8, and further including utilizing the word-like numeric entities in multilingual searches.

11. The computerized system of claim 9, wherein the universal system of annotation is a machine readable, multilingual sense dictionary (MSD) which includes:
i. the word-like numeric entities;
ii. substantially identical definitions in at least two natural languages for the word-like numeric entities; and
iii. expressions for each of the word-like numeric entities in each of the at least two natural languages.

12. The computerized system of claim 9, and further including increasing the vector format to a plurality of elements, for conjugating the numeric concept by various attributes.

13. The computerized system of claim 12, wherein the attributes also include an index of the source language word.

14. The computerized system of claim 12, wherein the universal system of annotation is a machine readable, multilingual sense dictionary (MSD) which includes:
i. the word-like numeric entities;
ii. substantially identical definitions in at least two natural languages for the word-like numeric entities; and
iii. expressions for each of the word-like numeric entities in each of the at least two natural languages,
wherein where the necessary expressions are formed as groups of words, the words in the group, which are to be conjugated in accordance with the various attributes indicated by the vector elements, are marked in the MSD, so as to allow replacing the word-like numeric entities with the expressions, correctly conjugated upon translation from the word-like numeric entities to any of the natural languages.

15. The computerized system of claim 9, wherein the universal system of annotation is a machine readable, multilingual sense dictionary (MSD) of the word-like numeric entities, the MSD including:
i. word-like numeric entities;
ii. substantially identical definitions in at least three languages for the word-like numeric entities; and
iii. expressions for the word-like numeric entities in each of the at least three languages.

16. The computerized system of claim 15, configured for providing a universal system of expression (USE), which is natural-language-free, the computerized system including:
an expression unit, for expressing an input of a natural language, having at least two terms and a well defined syntactic relationship in the natural language, between the terms, as word-like numeric entities;
a syntax unit for providing a syntactic code of syntax operators, for describing syntax operations; and
a universal system of expression unit for combining the word-like numeric entities and the syntax operators, to form universal expressions, free of sense and syntax associations with any natural language.

17. The computerized system of claim 16, configured for providing fully automatic ruled based machine translation from USE to the languages that are included in the MSD.

18. The computerized system of claim 17, configured for providing USE documents as byproducts of human-aided machine translations between any two natural languages that are included in the MSD, via interrogatory software, for fully automatic ruled based machine translation to other languages of the MSD.

19. The computerized system of claim 17, employed in multilingual communication.

20. A method for performing human-aided machine translation, including:
providing an input in a first natural language;
tagging the input in the first natural language with a universal system of annotation, linked at least to the first natural language and to a second natural language, thereby simultaneously defining meanings in both the first and the second natural languages, and ensuring that the meaning in the first language is preserved in the second language.

21. The method of claim 20, and further including associating the numeric concept with a vector format of a plurality of elements: a numeric concept element, a function element, and elements for various attributes, for conjugating the numeric concept, by function and by attributes, to create word-like numeric entities,
wherein the universal system of annotation is a machine readable, multilingual sense dictionary (MSD) which includes:
i. the word-like numeric entities;
ii. substantially identical definitions in at least three natural languages for the word-like numeric entities; and
iii. expressions for each of the word-like numeric entities in each of the at least three natural languages,
wherein the expressions for each of the word-like numeric entities in each of the at least three natural languages are provided by translators to the at least three languages working together, simultaneously translating the word-like numeric entities to the at least three languages and simultaneously ensuring translation agreement amongst the at least three languages.

22. Apparatus for freeing an input in one of a plurality of natural languages from syntax rules of the one natural language, including:
an input of at least two words, in the one natural language, combined by syntax rules of the one natural language, and associated with a meaning in the one natural language;
a syntax unit for providing symbols, as syntax operators, which describe syntax operations; and
a universal syntax unit for combining the at least two words with at least one syntax operator, to form at least one written expression, free of the syntax rules of the one natural language.
